(19) United States
(12) Patent Application Publication
(10) Pub. No.: US 2007/0113406 A1
(43) Pub. Date: May 24, 2007

(54) Energy absoption element

(76) Inventor: Norbert William Sucke, Duisburg (DE)

Correspondence Address: FRIEDRICH KUEFFNER, 317 MADISON AVENUE, SUITE 910, NEW YORK, NY, 10017, US

(21) Appl. No.: 10/580,789

(22) PCT Filed: Nov. 27, 2004
(86) PCT No.: PCT/EP04/13475

§ 371 Date: May 26, 2006

(30) Foreign Application Priority Data
Nov. 29, 2003 (DE) 103 55 913.2
Nov. 29, 2003 (DE) 203 18 501.3

(51) Int. Cl. B32B 3/12

(52) U.S. Cl. 29/897.1; 428/593

(57) ABSTRACT

The invention relates to an energy absorption element, comprising at least two multi-chamber hollow profiles (10, 11, 12). Said multi-chamber hollow profiles (10, 11, 12) have a planar profile cross-section with two parallel broad faces. The multi-chamber hollow profiles are arranged serially one behind the other in the energy absorption element, with the broad faces directed towards a possible occurring force (F) and connected to each other by the broad faces. A very high weight-specific energy absorption can be assured by the use of multi-chamber hollow profiles (multiport profiles, in particular, micro-multiport profiles). It is further possible to produce an energy absorption element with a required force/deformation path characteristic.

The invention concerns an energy absorber consisting of extruded multichamber hollow profiles, which have a flat profile in cross section with two parallel broad faces and curved or flat narrow faces.

The use of extruded aluminum profiles as energy absorbers for absorbing kinetic energy in motor vehicle collisions is well known. German Utility Patent DE 92 18 388 describes an impact absorber incorporated in a door.

DE 195 26 707 also describes an impact absorber with a profile which extends transversely to the longitudinal axis and is secured to the crossmember. This impact absorber is a multichamber profile. To increase the energy-absorbing capacity of extruded profiles of this type, the extruded profile of this previously known energy absorber is filled with aluminum foam. This type of construction provides high weight-specific energy absorption due to the aluminum foam. It is difficult to adapt the deformation behavior of these kinds of profiles to a specific application. This can be accomplished only by varying the wall thickness of the housing, since aluminum foam cannot be reproduced in the desired dimensions and cannot be produced with the same number of pores or pore sizes.

High weight-specific energy absorption is also achieved by honeycomb construction. In this type of construction, resin-impregnated paper, plastic, or light-metal hexagonal honeycombs are arranged between two cover plates. The use of these kinds of honeycomb constructions has the disadvantage that the use of different materials makes recycling difficult. These kinds of light-metal honeycomb constructions are usually produced from aluminum sheet. Strips of this aluminum sheet are bent into the desired shape, and two strips are joined together by brazing to form hexagonal cavities between them. A honeycomb cell structure of this type is described in International Patent Application WO 02/102539. However, this patent does not disclose how an energy absorber with predetermined deformation behavior can be produced with a structure of this type.

The objective of the invention is to create an energy absorbing member with high weight-specific energy absorption, which has a desired force-deformation characteristic.

This objective is achieved with an energy absorber of the type defined in Claim 1. An energy absorber of this type can be produced by a method according to Claim 21. The energy absorber of the invention provides very high weight-specific energy absorption due to the use of multichamber hollow profiles (multiport profiles), especially micro-multiport profiles. Any desired number of different multichamber hollow profiles can be joined together to form a structure. The multichamber hollow profiles are produced by extrusion of a light-metal alloy, preferably an aluminum alloy. Due to the material homogeneity of the overall structure, an energy absorber of this type can be readily recycled after use.

Due to steadily increasing safety requirements, especially with respect to the protection of the occupants of motor vehicles, a wide variety of absorption members are incorporated in the area around the passenger compartment. This is intended to reduce the risk of injury in a collision by absorbing as much kinetic energy as possible. Depending on the region of a motor vehicle in which the energy absorber is to be installed or on the possible impact stresses to which an energy absorber is exposed when used in other types of equipment, the energy absorber can be provided with a desired force-deformation characteristic by selection of the multichamber hollow profiles most suitable for the specific application. The number of same or different multichamber profiles can be varied as desired. The height and width of these profiles, the wall thickness of the outer wall and the chamber walls, the number of chambers, and the orientation of the profiles relative to one another can also be freely selected. Furthermore, different alloys can be used for different multichamber hollow profiles. In addition, different arrangements and shapes of the webs for a multichamber hollow profile can be provided, so that a specific, desired buckling behavior can be adjusted.

The extruded multichamber hollow profiles included in an energy absorber have a flat profile in cross section with two parallel broad faces. The multichamber hollow profiles (MP profiles, MMP profiles) are joined with one another along these flat, parallel, broad faces. The joining operation can involve a frictional or positive-locking connection by the use of suitable joining means, brazing, soldering, or adhesive bonding. When MMP profiles are used, an adhesive joint is preferred due to the thinness of the walls.

High weight-specific energy absorption is achieved with multichamber hollow profiles (MP profiles, MMP profiles) with a large number of chambers, preferably at least three chambers. When multichamber hollow profiles of this type are stacked and joined, a structure similar to a honeycomb is obtained. However, the deformation of the energy absorber in the direction of the application of the force can be predetermined by the selection of multichamber hollow profiles of different heights and cross sections.

Only multichamber hollow profiles with a ratio of width to height in the range of 3:1 to 40:1 are used. The wall thickness of the outer wall of these multichamber hollow profiles is in the range of 0.15 to 3 mm, preferably 0.15 to 1 mm, and especially 0.15 to 0.5 mm. The inner walls separating the chambers inside the multichamber hollow profile have a wall thickness of 0.1 to 3 mm, preferably 0.1 to 1 mm, and especially 0.1 to 0.5 mm.

To realize high weight-specific energy absorption, the multichamber hollow profiles are made of a light metal or light-metal alloy, preferably aluminum or an aluminum alloy.

The method of the invention comprises the production of multichamber hollow extruded profiles that have a flat profile in cross section with two flat, parallel, broad faces. The two broad faces of one profile are connected to each other by either flat or curved narrow faces. The broad faces and the narrow faces form the outer wall of the multichamber hollow profile. Adjoining chambers running longitudinally through the profile are separated from each other by inner walls. Different chamber cross sections in multichamber hollow profiles can be produced easily by extrusion. After extrusion, the still-hot hollow extruded profile is coated with a joining agent. A joining agent of this type can be a layer of zinc for soldering or a brazing mixture consisting of a brazing solder, a binder, and a flux. In addition, it is possible to apply an adhesive as a joining agent. If the adhesive is a thermosetting adhesive, it is not applied to the multichamber hollow extruded profile until after the profile has cooled to a temperature below the thermosetting temperature of the adhesive.

After the multichamber hollow extruded profile has been extruded, coated, and allowed to cool, it is cut to the desired length of the multichamber hollow profiles. This cutting process can be carried out at the extruder discharge outlet or in a separate location. In the latter case, the multichamber hollow extruded profiles can be coiled up and stored temporarily.

The selected, same or different multichamber hollow profiles are arranged one above the other and joined to obtain the desired energy absorber. According to the selected joining means, the profiles are joined by hot soldering, brazing, a clip connection, or adhesive bonding. If the multichamber hollow profiles consist of an alloy that can be artificially aged, they are joined by adhesive bonding, and the artificial aging and the curing of the adhesive to join the multichamber hollow profiles are preferably carried out in one process step.

Specific embodiments of the invention are explained in greater detail below with reference to the drawings.

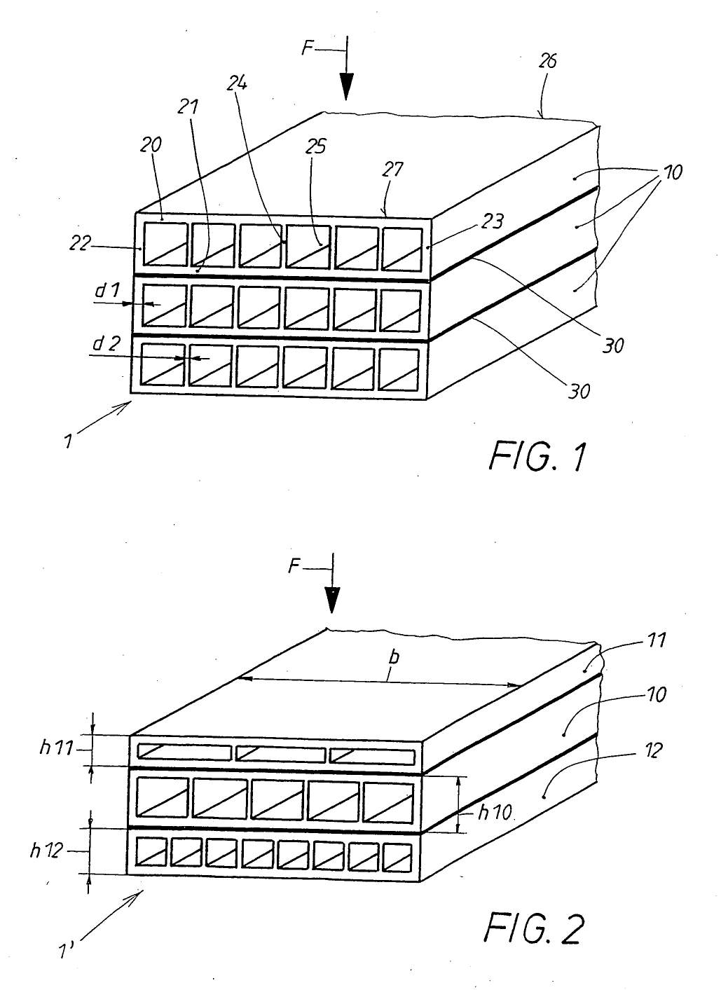

FIG. 1 shows a perspective view of an energy absorber of the invention made from identical multichamber hollow profiles.

FIG. 2 shows a perspective view of an energy absorber made from different kinds of multichamber hollow profiles.

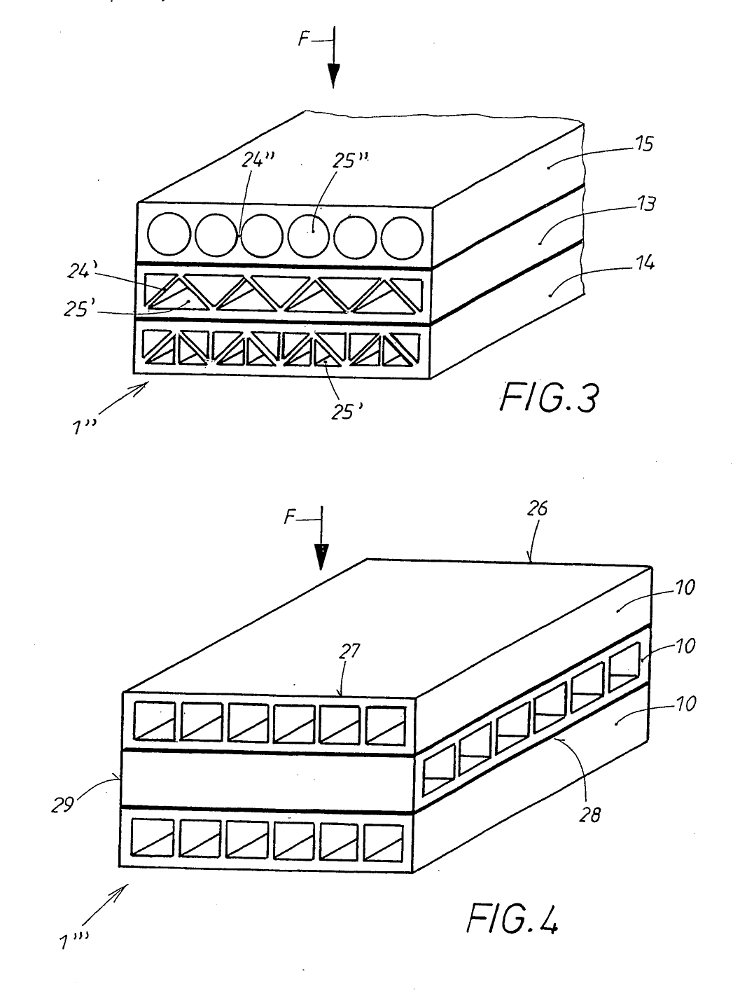

FIG. 3 shows a perspective view of an energy absorber made from different kinds of multichamber hollow profiles.

FIG. 4 shows a perspective view of an energy absorber made from identical multichamber hollow profiles.

The energy absorbers 1, 1′, 1″, 1′″ shown in FIGS. 1 to 4 each consist of three identical or different extruded multichamber hollow profiles 10, 11, 12, 13, 14, 15, 16. In contrast to previously known impact absorbers, at least two multichamber hollow profiles are joined by joining means 30, and the use of MP or MMP profiles is preferred. Naturally, it is also possible to install more than three multichamber hollow profiles in an energy absorber.

FIG. 1 shows an energy absorber 1 that consists of three identical multichamber hollow profiles 10. The multichamber hollow profiles 10 have a flat profile in cross section with two parallel flat, broad faces 20, 21, which, together with the narrow faces 22, 23, form the outer walls of the multichamber hollow profile 10. Each hollow profile 10 has several chambers 25 that run in the direction of the profile and are separated from each other by inner walls 24, which are perpendicular to the broad faces 20, 21. The wall thickness d1 of the outer wall, i.e., of the broad faces 20, 21 and of the narrow faces 22, 23, is 0.3 mm. The inner walls separating the chambers 25 have a wall thickness d2 of 0.2 mm. The multichamber hollow profiles 10 are joined with each other by an adhesive joint 30. The adhesive between the multichamber hollow profiles 10 ensures a joint of high shear strength between these multichamber hollow profiles 10 in the energy absorber 1. An energy absorber 1 of this type is installed, for example, in a vehicle in such a way that the broad faces 20, 21 are essentially perpendicular to the direction in which the force F is expected to act. In the force-deformation characteristic of an energy absorber 1 of this type, the force F would increase linearly until it encounters the broad face 20 of the first multichamber hollow profile 10, and then the impact energy is absorbed by this multichamber hollow profile 10. The hollow profile 10 deforms, which causes the slope of the characteristic in the force-distance graph to decrease. Due to the use of identical multichamber hollow profiles 10 in the energy absorber 1, the slope of the characteristic remains the same as a constant force F continues to be applied.

FIG. 2 shows another energy absorber 1′. It consists of different types of multichamber hollow profiles 11, 12, 16. The different multichamber hollow profiles 11, 12, 16 have the same width b but different heights. The multichamber hollow profile 11 has the smallest height h11. The multichamber hollow profile 16 with the greatest height h16 is underneath the multichamber hollow profile 11. The multichamber hollow profile 12 located farthest from an applied force F has a height h12. In addition, the multichamber hollow profiles 11, 12, 16 have different numbers of chambers 25. As a result of the different numbers of chambers and the variation of the height of the multichamber hollow profiles, different amounts of kinetic energy are absorbed by the individual multichamber hollow profiles 11, 12, 16.

FIG. 3 shows an energy absorber 1″, which consists of multichamber hollow profiles 13, 14, 15 with differently shaped chambers 25′, 25″. FIGS. 1 and 2 showed chambers with rectangular cross sections. The energy absorber 1′ has triangular chamber cross sections 25′ and circular chamber cross sections 25″. The chambers 25″, which have a cylindrical shape in the longitudinal direction of the profile, are separated from each other by inner walls 24″, and starting from the broad faces of the profile, the inner walls 24″ narrow towards the center of the profile and then widen again. The triangular chambers 25′ are formed by inner walls 24′, which are arranged obliquely to the broad faces in the multichamber hollow profile 13. In the multichamber hollow profile 14, besides the obliquely arranged inner walls 24′, inner walls 24 are provided that are perpendicular to the broad faces, so that between two obliquely arranged inner walls 24′, a vertically arranged inner wall 24 divides the space between the two obliquely arranged inner walls 24′ into two triangular chambers 25′. The differently shaped and arranged inner walls 24, 24′, 24″ exhibit different buckling behavior at the same weight. This can be important in energy absorbers when a force F does not act only in the perpendicular direction. Naturally, the multichamber profiles 13, 14, and 15 provided in the energy absorber 1″ can also be combined in any desired way with other multichamber hollow profiles 10, 11, 12, 16 to form a desired energy absorber.

FIGS. 1, 2, and 3 show energy absorbers 1, 1′, 1″ in which the chambers 25, 25′, 25″ of the multichamber profiles all extend in the same direction between the ends 26, 27 of the energy absorbers 1, 1′, 1″.

FIG. 4 shows an energy absorber 1′″ in which the multichamber profiles 10 are stacked one above the other and joined but in which the chambers extend in different directions. The uppermost multichamber profile 10 has rectangular chambers that extend parallel to one another between the ends 26, 27. The chambers of the lowermost multichamber profile 10 extend in the same direction. The middle multichamber profile 10 is oriented in such a way that the chambers extend between the ends 28 and 29 perpendicularly to the chambers of the multichamber profiles above and below the middle multichamber profile.

The illustrated specific embodiments of energy absorbers 1, 1′, 1″, 1′″ show the large number of possible variations by which a desired energy absorber can be produced with the use of multichamber profiles. The invention is not limited to the specific embodiments illustrated here.

### LIST OF REFERENCE SYMBOLS

1, 1′, 1″, 1′″ composite profile
10, 11, 12, 13, 14, 15, 16 multichamber profile
20, 21 broad face
22, 23 narrow face
24, 24′, 24″ inner wall
25, 25′, 25″ chamber
26, 27, 28, 29 ends
30 joining means
b width
d1 outer wall thickness
d2 inner wall thickness
h11 height of 11
h12 height of 12
h16 height of 16
F force

1. Energy absorber consisting of at least two extruded multichamber hollow profiles (10, 11, 12, 13, 14, 15, 16) made of aluminum or an aluminum alloy, which have a flat profile in cross section with two parallel broad faces (20, 21) and curved or flat narrow faces (22, 23), wherein the multichamber hollow profiles (10, 11, 12, 13, 14, 15, 16) are securely joined to each other along their parallel broad faces (20, 21), wherein identical or different multichamber hollow profiles (10, 11, 12, 13, 14, 15, 16) are arranged in succession in the energy absorber (1, 1′, 1″, 1′″) with their broad faces (20, 21) facing a possible force (F) that may act on them; and in that the multichamber hollow profiles (10, 11, 12, 13, 14, 15, 16) each have a width b and a height h, wherein the ratio of width b to height h is in the range of b:h=3:1 to b:h=40:1, and in that multichamber hollow profiles (10, 11, 12, 13, 14, 15, 16) are provided with the same and/or different wall thicknesses (d1) of the outer wall (20, 21, 22, 23), where the wall thickness (d1) of the outer wall (20, 21, 22, 23) is in the range of 0.15-3 mm.

2. Energy absorber according to claim 1, wherein the multichamber hollow profiles (10, 11, 12, 13, 14, 15, 16) have at least three chambers (25, 25′, 25″) extending in the longitudinal direction of the profile.

3. Energy absorber according to claim 2, wherein the multichamber hollow profiles (10, 11, 12, 13, 14, 15, 16) are provided with the same and/or different numbers of chambers (25, 25′, 25″).

4. Energy absorber according to claim 2, wherein the chambers (25) in the multichamber hollow profiles (10, 11, 12) are separated by flat inner walls (24) that are arranged perpendicularly between the broad faces (20, 21) and extend in the longitudinal direction of the profile, so that rectangular chamber cross sections are formed.

5. Energy absorber according to claim 2, wherein the chambers (25′) in the multichamber hollow profiles (13, 14) are separated by flat inner walls (24, 24′) that are arranged perpendicularly and/or obliquely between the broad faces (20, 21) and extend in the longitudinal direction of the profile, so that triangular chamber cross sections are formed.

6. Energy absorber according to claim 2, wherein the chambers (25″) in the multichamber hollow profiles (15) are separated by curved inner walls (24″) that are arranged between the broad faces (20, 21) and extend in the longitudinal direction of the profile.

7. Energy absorber according to claim 4, wherein multichamber hollow profiles (10, 11, 12, 13, 14, 15, 16) are provided with the same and/or different chamber cross sections.

8. Energy absorber according to claim 1, wherein multichamber hollow profiles (10, 11, 12, 13, 14, 15, 16) are provided with the same and/or different widths b.

9. Energy absorber according to claim 1, wherein multichamber hollow profiles (10, 11, 12, 13, 14, 15, 16) are provided with the same and/or different heights h.

10. Energy absorber in accordance with claim 1, wherein the multichamber hollow profiles (10, 11, 12, 13, 14, 15, 16) have a wall thickness (d1) of the outer wall (20, 21, 22, 23) of 0.15-1 mm, and preferably of 0.15-0.5 mm.

11. Energy absorber in accordance with claim 1, wherein the multichamber hollow profiles (10, 11, 12, 13, 14, 15, 16) have a wall thickness (d2) of the inner walls (24, 24′, 24″) that separate the chambers (25, 25′, 25″) of 0.1-3 mm, preferably of 0.1-1 mm, and especially of 0.1-0.5 mm.

12. Energy absorber according to claim 11, wherein multichamber hollow profiles (10, 11, 12, 13, 14, 15, 16) are provided with the same and or different wall thicknesses (d2) of the webs.

13. Energy absorber in accordance with claim 1, wherein the multichamber hollow profiles (10, 11, 12, 13, 14, 15, 16) are joined to each other positively or preferably by soldering, brazing or adhesive bonding.

14. Energy absorber according to claim 13, wherein the multichamber hollow profiles (10, 11, 12, 13, 14, 15, 16) are joined to each other by a thermosetting adhesive (30).

15. Energy absorber in accordance with claim 1, wherein the identical or different multichamber hollow profiles (10, 11, 12, 13, 14, 15, 16) joined positively to each other are oriented relative to each other in such a way that the longitudinal axes of adjoining multichamber hollow profiles (10, 11, 12, 13, 14, 15, 16) are parallel to each other.

16. Energy absorber in accordance with claim 1, wherein the identical or different multichamber hollow profiles (10, 11, 12, 13, 14, 15, 16) joined positively to each other are oriented relative to each other in such a way that the longitudinal axes of adjoining multichamber hollow profiles (10, 11, 12, 13, 14, 15, 16) are at an angle to each other.

17. Method for producing an energy absorber
by extruding multichamber hollow profiles of aluminum or an aluminum alloy with a flat profile in cross section with two parallel broad faces (20, 21) and curved or flat narrow faces (22, 23) and with at least three chambers (25, 25′, 25″) extending in the longitudinal direction of the profile;
by coating the still-hot multichamber hollow extruded profiles leaving the extruder with joining means (30);
by cooling the coated multichamber hollow extruded profiles and then cutting them to the desired lengths of the multichamber hollow profiles (10, 11, 12, 13, 14, 15, 16);
by repeating the process for a different profile cross section; and
by arranging identical or different multichamber hollow profiles (10, 11, 12, 13, 14, 15, 16) one above the other and joining them together.

18. Method according to claim 17, wherein multichamber hollow extruded profiles are extruded with preformed joining means, which allow the multichamber hollow profiles to be clamped in place in the energy absorber element.

19. Method according to claim 17, wherein the joining means (30) with which the broad faces (20, 21) of the multichamber hollow extruded profiles are coated is zinc, a brazing mixture, or an adhesive.

20. Method according to claim 19, wherein the adhesive is a thermosetting adhesive.

21. Method according to claim 19, wherein the multichamber hollow profiles (10, 11, 12, 13, 14, 15, 16) are joined by the action of heat.

22. Method according to claim 21, wherein the multichamber hollow profiles (10, 11, 12, 13, 14, 15, 16) consist of an aluminum alloy that can be artificially aged, such that the artificial aging and the curing of the adhesive to join the multichamber hollow profiles (10, 11, 12, 13, 14, 15, 16) are carried out in a single process step.
